(19) United States
(12) Patent Application Publication
(10) Pub. No.: US 2010/0049367 A1
(43) Pub. Date: Feb. 25, 2010

(54) METHOD OF CONTROLLING ROBOT FOR BRIDGE INSPECTION

(76) Inventor: Kyung-Taek Yang, Anyang-si (KR)

Correspondence Address: SHERR & VAUGHN, PLLC, 620 HERNDON PARKWAY, SUITE 320, HERNDON, VA, 20170, US

(21) Appl. No.: 12/425,492

(22) Filed: Apr. 17, 2009

(30) Foreign Application Priority Data
Aug. 25, 2008 (KR) 10-2008-0083028

(51) Int. Cl. G05B 15/00

(52) U.S. Cl. 700/259

(57) ABSTRACT

The present invention relates to a method of controlling a robot for bridge inspection. In the present invention, whether a defect image is being received from a robot device is determined. As a result of the determination, when the defect image is being received, a current location of the robot device is stored. Whether a predetermined period of time has been elapsed after the storage of the current location is determined. When the predetermined period of time has elapsed, a control command for moving the robot device to a prestored location is output. Whether a defect image at a same location as the prestored location is being received is determined. When the defect image at the same location is being received, a defect image at a previous time is compared with a defect image at a current time. A result of the comparison is displayed.

### BACKGROUND OF THE INVENTION

1. Field of the Invention

The present invention relates, in general, to a method of controlling a robot for bridge inspection, and, more particularly, to a method of controlling a robot for bridge inspection, which moves a robot equipped with a camera to a desired location along a rail installed under a bridge, thus inspecting the status of the bridge.

2. Description of the Related Art

Recently, methods of economically and efficiently performing the inspection of the appearance of the lower structure of a bridge, a periodic inspection difficult to conduct with the naked eye, have been required when inspection is conducted to examine the response level to aging of large-scale structures such as bridges.

Industry-related basic facilities such as bridges are periodically examined for safety and inspected to guarantee their safety. Primarily, whether structures are cracked or corroded has been examined based on the inspection of appearance.

An existing inspection method is performed in such a way that, as shown in FIG. 1, a workbench such as a scaffold 3, a movement path, and a foothold are installed under a bridge under which water flows, and a worker 2 inspects the status of corrosion and cracking of the bridge on the scaffold 3. Such an inspection method is disadvantageous in that large costs are required to install the workbench such as a scaffold above the water under the bridge, and the safety of the worker cannot be guaranteed because the workbench sways due to strong winds on a windy day.

Further, there is a method of putting a worker on a ladder and examining the bottom of the deck of a bridge using an articulating ladder truck 4 which has recently been introduced. However, this method has a difficulty in that, in the case of a suspension bridge or a cable stayed bridge, the ladder must be moved each time to locations between respective cables, as shown in FIG. 2, and has a problem in that the safety of a worker cannot be guaranteed.

### SUMMARY OF THE INVENTION

Accordingly, the present invention has been made keeping in mind the above problems occurring in the prior art, and an object of the present invention is to provide a method of controlling a robot for bridge inspection, which moves a robot equipped with a camera to a desired location along a rail installed under a bridge, so that the status of the bridge is inspected, thus enabling real-time monitoring.

In order to accomplish the above object, the present invention provides a method of controlling a robot for bridge inspection, the method controlling a robot device in a robot control system including the robot device for moving to a desired location to inspect a status of a bridge, acquire a state of a defect at the location as an image and transmit the image; and a monitoring device connected to the robot device to enable wireless communication and configured to control a location of the robot device, analyze the image received from the robot device and monitor the robot device, comprising a primary defect measurement step comprising a camera posture control step of controlling a posture of the camera by controlling an inclination angle of a central axis of the camera with a ground and a rotation angle of a projection axis, formed when the central axis is projected onto the ground, with a reference axis; an image acquisition step of acquiring an optimal image by controlling a control motor for controlling a focus of the camera and a control motor for controlling a zoom-in/zoom-out function of the camera; when a defective region is detected in the image acquired by the camera, determining a width and a length of the defective region; and when the image is determined to be a defect image as a result of the determination, storing the defect image, a current location of the robot device, and a current location of the camera; determining, when the primary defect measurement step has been completed, whether a predetermined period of time has elapsed after storing the defect image; if it is determined that the predetermined period of time has elapsed, extracting information about the location of the robot device and the location of the camera, at which the defect was detected at the primary defect measurement step, and outputting a control command for moving the robot device; moving the robot device and the camera to a same location where the defect was measured in compliance with the control command; acquiring an image at the same location; checking the defect image from the acquired image and comparing the defect image at a previous time with the defect image at a current time; and displaying a result of the comparison.

Preferably, the method may further comprise before the camera posture control step, an origin movement step of setting a desired location as an origin and moving the robot device to the origin; and a velocity conversion input step of receiving a movement velocity and an acceleration of the robot device and determining a movement velocity of the robot device depending on magnitudes of the received velocity and acceleration.

Preferably, the method may further comprise a defect determination step of determining whether a target abnormal region to be determined to be a defect is included in the image at a time of determining the defect image, clicking a mouse depending on a width and a length of the abnormal region, measuring the length and width of the abnormal region, and determining that the abnormal region is a defect when the measured length and width are greater than predetermined sizes.

Preferably, the method may further comprise, after the primary defect measurement step, an origin return step of returning the robot device to the stored origin in compliance with an origin return command; a quick movement step of setting and storing a desired location while a movement track of the robot device is being stored during movement of the robot device, and moving the robot device to the set location in compliance with a set location movement command; and a quick image acquisition step of continuously storing a track of an inclination angle of the central axis of the camera, required for image acquisition, with the ground, a track of a rotation angle of the projection axis, formed when the central axis is projected onto the ground, with the reference axis, a track of a rotation angle of the focus control motor of the camera, and a track of a rotation angle of the zoom-in/zoom-out control motor of the camera while acquiring continuous images through the camera, and, if an image to be reviewed is set, storing an inclination angle of the central axis of the camera with the ground, a rotation angle of the projection axis, formed when the central axis is projected onto the ground, with the reference axis, and a rotation angle of the zoom-in/zoom-out control motor of the camera at a time at which the set image was acquired, and thereafter adjusting a location and status of the camera using the stored values in compliance with a set image acquisition command, thus acquiring the set image.

Preferably, the origin return step may be performed to store values of an encoder connected to wheels at a time of setting the origin and move to the origin using the stored encoder values, the camera posture control step may be performed to control the posture of the camera using both a value of an encoder connected to a motor for adjusting an angle of the central axis of the camera with the ground and a value of an encoder connected to a motor for adjusting an angle of the projection axis, formed when the central axis is projected onto the ground, with the reference axis, the image acquisition step may be performed to acquire the image by controlling the camera using a value of an encoder connected to the focus control motor of the camera and a value of an encoder connected to the zoom-in/zoom-output control motor of the camera, and the quick image acquisition step may be performed to acquire a quick image using both the value of the encoder connected to the motor for adjusting the angle of the central axis of the camera with the ground, and the value of the encoder connected to the motor for adjusting the angle of the projection axis, formed when the central axis of the camera is projected onto the ground, with the reference axis.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a conventional bridge inspection method according to an embodiment;

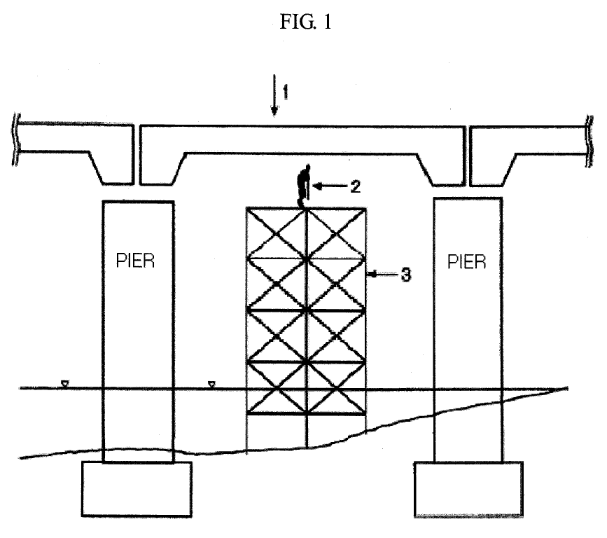

FIG. 2 is a diagram showing a conventional bridge inspection method according to another embodiment;

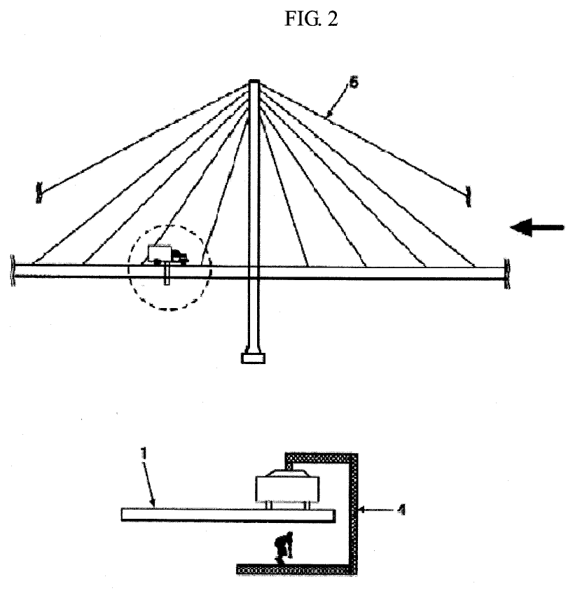

FIG. 3 is a schematic diagram showing the implementation of a robot system for bridge inspection applied to the present invention;

FIG. 4 is a detailed block diagram showing the robot device of the robot system for bridge inspection applied to the present invention;

FIG. 5 is a detailed block diagram showing the monitoring device of the robot system for bridge inspection according to the present invention;

FIG. 6 is a flowchart showing a method of controlling a robot according to an embodiment of the present invention;

FIG. 7 is a diagram showing the status of the screen of the monitoring device of FIG. 5;

FIG. 8 is a diagram showing the status of the screen enabling a velocity and an acceleration to be input; and

FIG. 9 is a diagram showing a form related to the posture of a camera.

### DESCRIPTION OF THE PREFERRED EMBODIMENTS

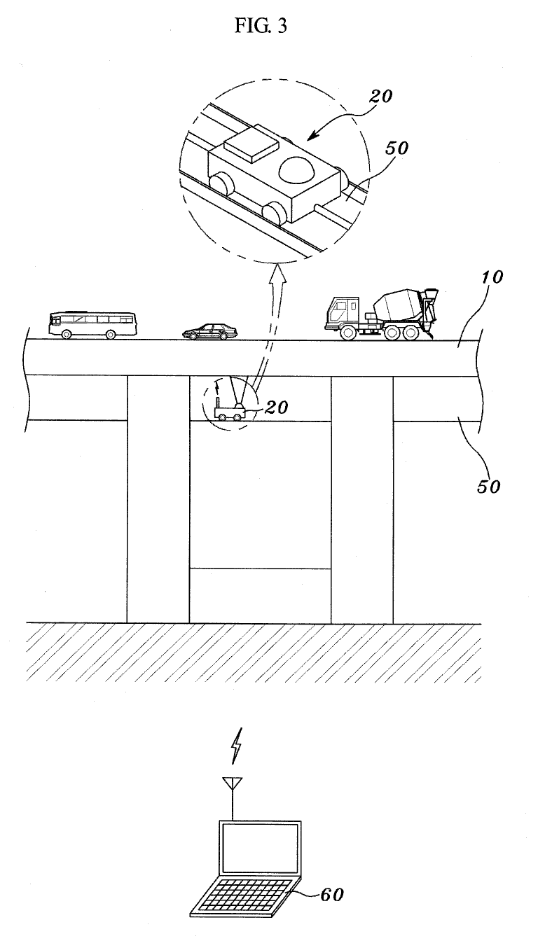

Hereinafter, embodiments of the present invention will be described in detail with reference to FIGS. 3 to 6.

FIG. 3 is a schematic diagram showing the implementation of a robot system for bridge inspection applied to the present invention.

Referring to FIG. 3, the robot system includes a robot device 20 and a monitoring device 60 which are connected to each other to enable wireless communication. In this case, a rail 50 is installed between piers of the bridge, and the robot system includes the robot device 20 moving along the rail 50, and the monitoring device 60 configured to wirelessly control the robot device 20 and monitor the status of a deck 10 from image signals received from the robot device 20. The robot device 20 includes a motor, which is movable vertically and horizontally along the rail 50 and is rotatable, so as to inspect the status of the bottom of the deck 10.

Therefore, the robot device 20 is moved to a desired location in response to a control signal output from the monitoring device 60 and is configured to acquire an image of the location using its own camera. Further, the robot device 20 transmits the acquired image to the monitoring device 60. The monitoring device 60 may be connected to the robot device 20 in a wireless manner and configured to output a control signal for controlling the robot device 20 and inspect and monitor the status of the deck 10 from the image acquired by the robot device 20.

The camera of the robot device 20 may function to estimate the state and width of the crack of a structure placed at a certain capturing distance by controlling a focus and zoom-in function. Further, the camera of the robot device 20 employs a high-magnification zoom lens to be capable of horizontally rotating at an angle of 360° and vertically rotating at an angle of 90°, thus enabling inspection to be conducted in all directions under the bridge. The camera of the robot device 20 transmits the acquired image to the monitoring device 60. Image processing is performed on the transmitted image by the monitoring device 60, and image analysis is performed on the processed image such as by calculating the width and length of the crack, so that the analyzed image is stored. Such image analysis data is stored in the monitoring device 60 so that it can be compared and analyzed later with the results of the inspection.

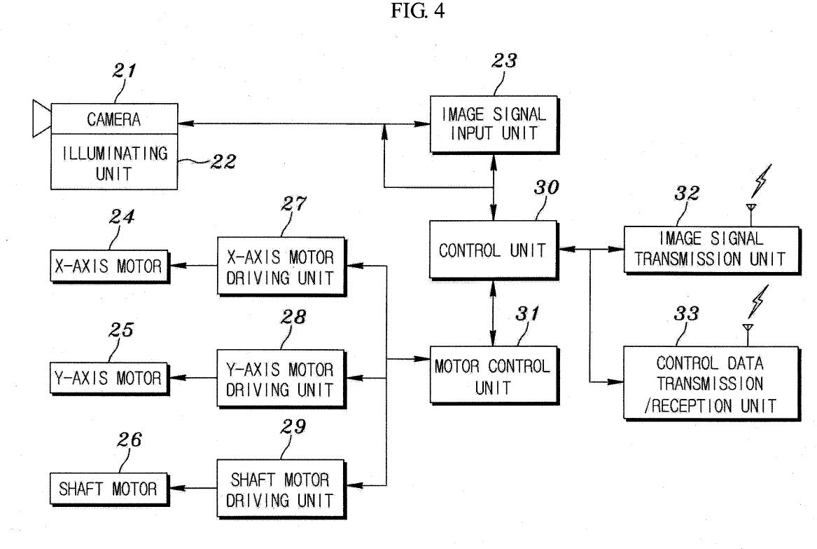

FIG. 4 is a detailed block diagram of the robot device applied to the present invention.

Referring to FIG. 4, the robot device 20 includes a camera 21 formed to be integrated with an illuminating unit 22, an image signal input unit 23 for receiving an image signal from the camera 21, an X-axis motor 24, a Y-axis motor 25 and a shaft motor 26 for moving the robot device 20 along an X axis, a Y axis and a shaft, respectively, and an X-axis motor driving unit 27, a Y-axis motor driving unit 28 and a shaft motor driving unit 29 for driving the motors 24, 25 and 26, respectively. Further, the robot device 20 includes a motor control unit 31 for controlling the respective motor driving units 27, 28 and 29, a control unit 30 for controlling the respective components, an image signal transmission unit 32 for transmitting image signals, and a control data transmission/reception unit 33 for transmitting or receiving control data.

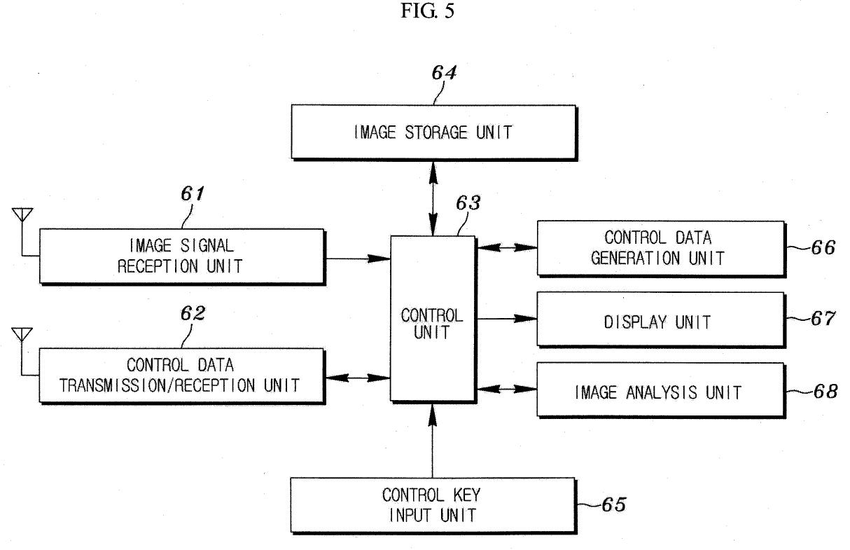

FIG. 5 is a detailed block diagram of the monitoring device applied to the present invention.

Referring to FIG. 5, the monitoring device 60 includes an image signal reception unit 61 for receiving image signals from the robot device 20, a control data transmission/reception unit 62 for transmitting or receiving control data to or from the robot device 20, an image storage unit 64 for storing the received images, an image analysis unit 68 for analyzing the received images, a control data generation unit 66 for generating control data, required to control the robot device 20, in conformity with standard requirements for transmission, a control key input unit 65 for receiving a control key for controlling the robot device 20, and a display unit 67 for outputting the results of the analysis of the images.

A detailed operation of the robot system for bridge inspection applied to the present invention will be described below using the robot device of FIG. 4 and the monitoring device 60 of FIG. 5, constructed in this way.

The robot device 20 of FIG. 4 is installed on the rail under the bridge, and the monitoring device 60 of FIG. 5 is installed at a location enabling the transmission or reception of wireless signals so as to control the robot device 20.

Referring to FIG. 5, a worker inputs the control key for controlling the robot device 20 through the control key input unit 65 of the monitoring device 60. The control unit 63 outputs to the control data generation unit 66 a control signal for moving the robot device 20 to a desired location and acquiring an image of a defective place on the basis of the control key input through the control key input unit 65 by a worker. The control data generation unit 66 converts the control signal received from the control unit 63 into control data complying with communication standards so that the control signal can be transmitted as a wireless signal, and outputs the control data to the control unit 63. In this case, the wireless signal complying with communication standards may be, for example, a signal for Bluetooth. The control unit 63 outputs the control signal, converted into the control data complying with communication standards such as Bluetooth, to the control data transmission/reception unit 62. Then, the control data transmission/reception unit 62 transmits the control data to the robot device 20.

Meanwhile, referring to FIG. 4, the control data transmission/reception unit 33 receives the control data from the monitoring device 60 and outputs the control data to the control unit 30. When the received control data is a motor control signal for the movement of a location, the control unit 30 outputs the control data to the motor control unit 31. The motor control unit 31 controls the motor driving units 27, 28 and 29 which drive the motors 24, 25 and 26, respectively, to move the robot device 20 to a desired location in response to the control data. Then, the robot device 20 is moved to the desired location by the manipulation of the worker. At this time, when the control data is control data required to control the camera 21 and the illuminating unit 22, the control unit 30 controls the camera 21 and the illuminating unit 22. Therefore, a desired image can be acquired using the desired illuminating unit 22 by moving the camera 21. The camera 21 outputs the acquired image to the image signal input unit 23.

The image signal input unit 23 outputs the acquired image, including a defect, to the control unit 30, and the control unit 30 outputs the acquired image to the image signal transmission unit 32. The image signal transmission unit 32 transmits the received image signal to the monitoring device 60.

The image signal reception unit 61 of FIG. 5 receives the image signal and outputs the image signal to the control unit 63. The control unit 63 stores the image signal in the image storage unit 64, and outputs the image signal to the image analysis unit 68. The image analysis unit 68 analyzes the status of the defect by analyzing the image signal, and outputs the results of the analysis to the control unit 63. The control unit 63 not only stores an image corresponding to the results of the analysis in the image storage unit 64, but also notifies the worker of the results of the analysis through the display unit 67, thus allowing the worker to perform real-time monitoring.

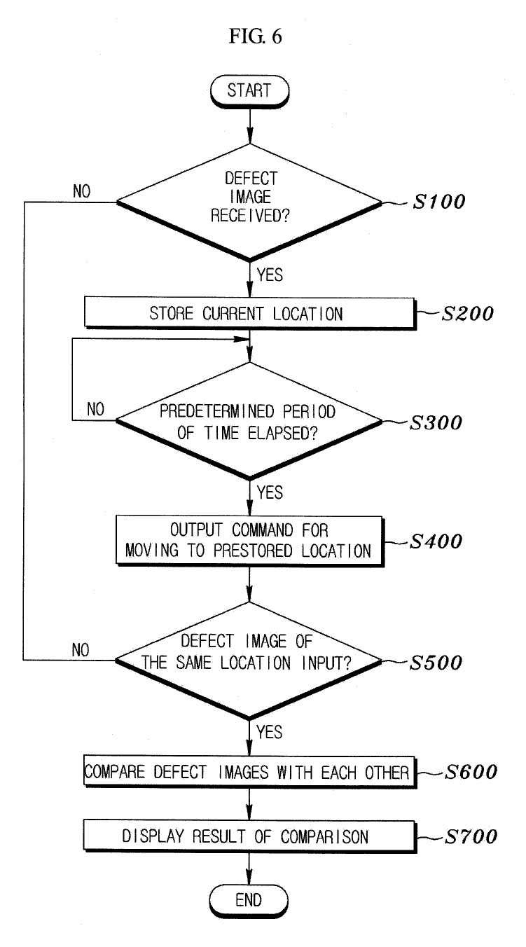

A robot control method according to the present invention of controlling the robot device 20 through the monitoring device 60 will be described with reference to FIG. 6.

FIG. 6 is a control flowchart of the robot control method according to an embodiment of the present invention.

Referring to FIG. 6, the control unit 63 of the monitoring device 60 determines whether an image having a defect (hereinafter referred to as a ‘defect image’) is being received from the robot device 20 at step S100. If it is determined that the defect image is being received, the control unit 63 stores the current location of the robot device 20 at that time at step S200. Further, the control unit 63 determines whether a predetermined period of time has elapsed at step S300. If it is determined that the predetermined period of time has elapsed, the control unit 63 outputs a control command required to move the robot device 20 to a prestored location at step S400. The robot device 20 is moved to the same location where the defect image was captured before, captures an image of the same location and transmits the captured image. The control unit 63 determines whether a defect image of the same location is being received at step S500, and stores the received defect image. Further, the control unit 63 reads the defect image at the previous time and the defect image at the current time and compares the defect images with each other at step S600. As a result of the comparison, the control unit 63 determines whether the status of the defect has varied from that of the previous time, and outputs the result of the comparison to the display unit at step S700.

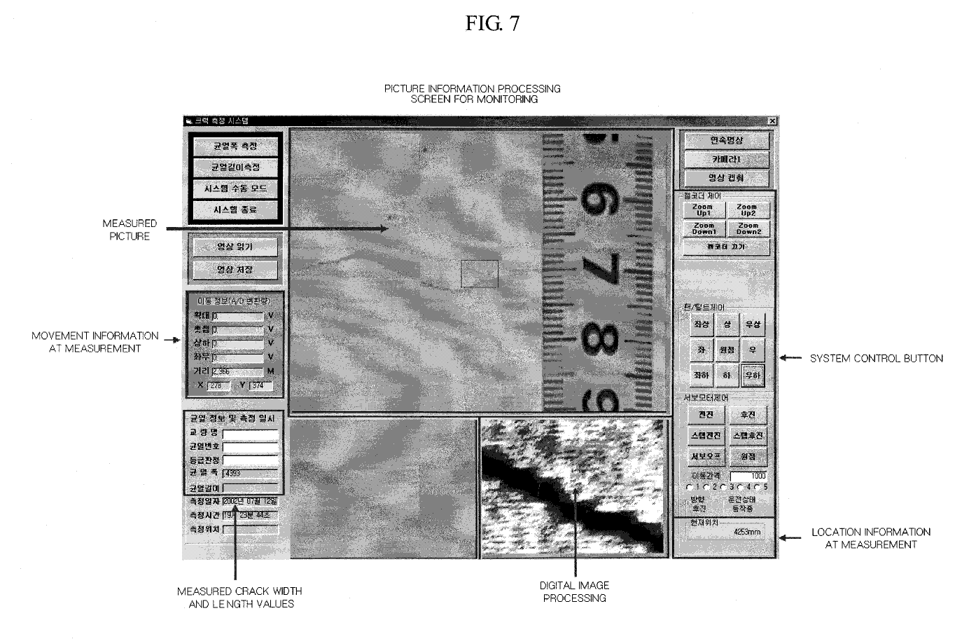

FIG. 7 is a diagram showing the status of the screen of the monitoring device of FIG. 5.

Referring to FIG. 7, the shape of a cracked portion in a measured picture can be monitored through an image, system control buttons for controlling the system are provided, and information about the location at the time of measurement is also included in the screen. Further, at the time of measurement, the movement information of the robot device 20 and the width and length of a crack, which are measured by the robot device 20, are digitized and shown. The worker may acquire a defect image at another location by viewing the above screen status and inputting again a control key for moving the robot device 20, thus continuously monitoring various locations.

The robot device of the present invention includes a motor for driving wheels, a motor for controlling the posture of the camera, and a motor for controlling the focus and zoom-in/zoom-out function of the camera. Encoders for detecting the locations of the motors are attached to all of the motors.

The values of the encoders are stored and utilized at the origin movement step of setting a desired location as the origin and moving the robot device to the set origin, the camera posture control step of controlling the posture of the camera using both an inclination angle of the central axis of the camera with the ground and a rotation angle of a projection axis, formed when the central axis is projected onto the ground, with the reference axis, and the camera control step of controlling the camera using a rotation angle of the focus control motor of the camera and a rotation angle of the zoom-in/zoom-out control motor of the camera.

The origin movement step of setting a desired location as the origin and moving the robot device to the set origin is performed such that, when the robot device is moved to the location of the origin, this movement is performed using only the manipulation of an origin set button without requiring a specific operation, thus enabling the robot device to conveniently move to the origin.

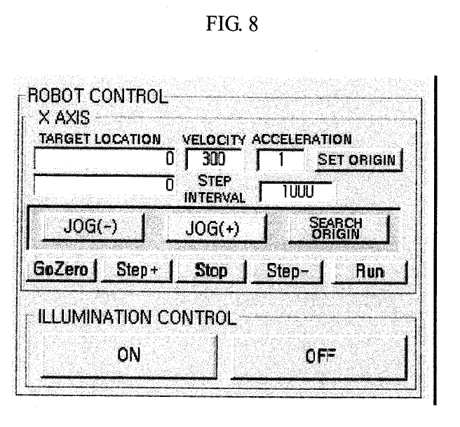

FIG. 8 is a diagram showing a screen for inputting a velocity and an acceleration as numbers and setting the origin.

Referring to FIG. 8, the velocity and the acceleration are input as numbers, and a button enabling the origin to be set as a desired location is provided on the screen.

The “origin” in the present invention being determined by the user according to the situation of the field is very advantageous for the detection of defects in a variety of regions and then the returning back to an original position.

The present invention has a velocity conversion input module for receiving the movement velocity and acceleration of the robot device and determining the movement velocity of the robot device depending on the magnitudes of the received velocity and acceleration.

Here, the movement velocity and the acceleration values are received as digital values. In the present invention, the velocity is set as a value between 1 and 500, and the acceleration is set as a value between 1 and 3. The unit of velocity is m/min or m/sec, and is set as a suitable velocity according to the environment. The acceleration is suitably determined by the user according to the environment.

Further, the present invention is capable of moving the robot device to a desired location. That is, the step of moving the robot device to the desired location is performed to set the current location of the robot as the origin by pressing a “Set Origin” button, and to input a desired distance into a ‘Step Interval’ field. In the present invention, the unit of step interval is mm. Next, when a “Step+” button is pressed, the robot device is moved forwards by a distance set in the ‘Step Interval’ field, whereas when a “Step−” button is pressed, the robot device is moved backwards by that amount. Next, when a “Stop” button is pressed during movement, the robot device is stopped. When a “Run” button is pressed, the robot device continues to perform the previous operations thereof. When the robot device intends to move to the initially set origin, a “GoZero” button is pressed, and thus the robot device is returned to the origin.

The present invention includes the quick movement step of, when a desired location is set during the movement of the robot device while the movement track of the robot device is stored, storing the set location and moving the robot device to the set location in compliance with a set location movement command.

The quick movement step is performed by a module for quickly moving the robot device to a desired location through only simple manipulation if the desired location is set when the user desires to move the robot device to the desired location as needed during the movement of the robot device.

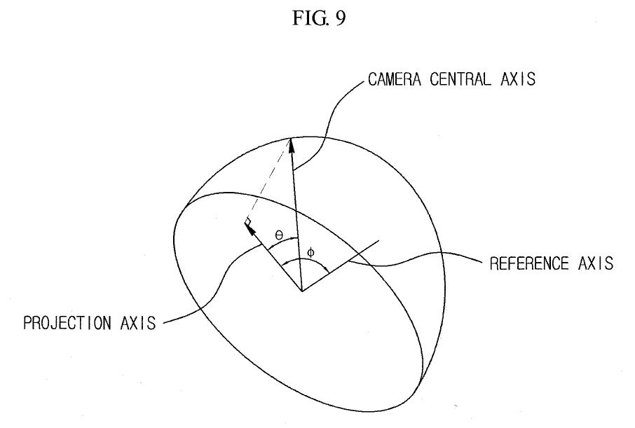

FIG. 9 is a diagram showing a structure related to the posture of the camera.

Referring to FIG. 9, the posture of the camera is configured such that the camera can be placed at any location on a hemisphere. In this case, when the longitudinal axis of the camera (the axis passing through the center of the image-formation plane of the camera) is set as the central axis, an angle 0 of the central axis of the camera with the ground is set as one variable, and an angle φ of a projection axis, formed when the central axis is projected onto the ground, with a reference axis is set as another variable, the image-formation plane of the camera may be located at any location on the hemisphere using the two variables, and thus images at any location may be acquired.

Here, the term ‘reference axis’ means an axis passing through the origin drawn in a radial direction from the center of a circle drawn on the ground (the circle formed when the hemisphere meets the ground).

Further, the present invention has a quick image acquisition module. At the time of acquiring continuous images using the camera, the quick image acquisition module continuously stores the track of the inclination angle of the central axis of the camera, required for image acquisition, with the ground, the track of the rotation angle of the projection axis, formed when the central axis is projected onto the ground, with the reference axis, the track of the rotation angle of the focus control motor of the camera, and the track of the rotation angle of the zoom-in/zoom-out control motor of the camera. If an image desired to be reviewed is set while the above variables are stored, the quick image acquisition module stores variables required to acquire the set image, that is, an inclination angle of the central axis of the camera with the ground, a rotation angle of the projection axis, formed when the central axis is projected onto the ground, with the reference axis, and a rotation angle of the zoom-in/zoom-out control motor of the camera, and adjusts the location and status of the camera using the stored values in compliance with a set image acquisition command, thus acquiring the set image.

Here, the location of the camera is determined by both the inclination angle of the central axis with the ground and the rotation angle of the projection axis, formed when the central axis is projected onto the ground, with the reference axis. The status of the camera is determined by both the rotation angle of the focus control motor of the camera and the rotation angle of the zoom-in/zoom-out control motor of the camera.

Furthermore, the present invention includes an origin return step and the camera posture control step. The origin return step is performed to store the values of the encoders connected to the wheels at the time of setting the origin, and moving the robot device to the origin using the stored encoder values. The camera posture control step is performed to control the posture of the camera using both the value of the encoder connected to the motor for controlling an angle of the central axis of the camera with the ground and the value of the encoder connected to the motor for controlling an angle of the projection axis, formed when the central axis is projected onto the ground, with the reference axis.

Therefore, the present invention provides an advantage in that, when the appearance of the bottom of the deck of a bridge is inspected, a robot, the location of which can be freely adjusted, is controlled in a wireless manner, so that images of defects at desired locations can be continuously acquired.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-5. (canceled)

6. A method of controlling a robot for bridge inspection, the method controlling a robot device in a robot control system including the robot device for moving to a desired location to inspect a status of a bridge, acquire a state of a defect at the location as an image and transmit the image; and a monitoring device connected to the robot device to enable wireless communication and configured to control a location of the robot device, analyze the image received from the robot device and monitor the robot device, comprising:
a primary defect measurement step including:
controlling a posture of the camera by controlling an inclination angle of a central axis of the camera to ground and a rotation angle of a projection axis, formed when the central axis is projected onto the ground, with a reference axis;
acquiring a first image by controlling a control motor for controlling a focus of the camera and a control motor for controlling a zoom function of the camera;
determining a width and a length of a defective region when a defect is detected in the first image acquired by the camera; and
storing a first defect image of the defective region, a current location of the robot device, and a current location of the camera when the first image is determined to show a defect as a result of the determining a width and length of a defective region;
determining, when the primary defect measurement step has been completed, whether a predetermined period of time has elapsed after storing the first defect image;
if the predetermined period of time has elapsed, extracting information about the location of the robot device and the location of the camera, at which the defect was detected in the primary defect measurement step, and outputting a control command for moving the robot device;
moving the robot device and the camera to a same location where the defect was measured in compliance with the control command;
acquiring a second image at the same location having a second defect image;
checking the second defect image from the acquired second image and comparing the first defect image with the second defect image; and
displaying a result of the comparison.

7. The method according to claim 6, further comprising, before controlling the posture of the camera:
setting a desired location as an origin and moving the robot device to the origin; and
a velocity conversion input step of receiving a velocity and an acceleration of the robot device and determining a movement velocity of the robot device depending on magnitudes of the received velocity and acceleration.

8. The method according to claim 7, further comprising, after the primary defect measurement step:
returning the robot device to a stored origin in compliance with an origin return command;
setting and storing a desired location while a movement track of the robot device is being stored during movement of the robot device, and moving the robot device to a set location in compliance with a set location movement command; and
continuously storing a track of an inclination angle of the central axis of the camera, required for image acquisition, with the ground, a track of a rotation angle of the projection axis, formed when the central axis is projected onto the ground, with the reference axis, a track of a rotation angle of the focus control motor of the camera, and a track of a rotation angle of the zoom control motor of the camera while acquiring continuous images through the camera, and, if an image to be reviewed is set, storing an inclination angle of the central axis of the camera with the ground, a rotation angle of the projection axis, formed when the central axis is projected onto the ground, with the reference axis, and a rotation angle of the zoom control motor of the camera, at a time at which the set image was acquired, and thereafter adjusting a location and status of the camera using the stored values in compliance with a set image acquisition command, thus acquiring the set image.

9. The method according to claim 8, wherein:
said returning the robot device to a stored origin includes storing values of an encoder connected to wheels at a time of setting the origin and moving to the origin using the stored encoder values;
said controlling a posture of the camera includes using both a value of an encoder connected to a motor for adjusting an angle of the central axis of the camera with the ground and a value of an encoder connected to a motor for adjusting an angle of the projection axis, formed when the central axis is projected onto the ground, with the reference axis,
said acquiring a first image acquires the image by controlling the camera using a value of an encoder connected to the focus control motor of the camera and a value of an encoder connected to the zoom control motor of the camera, and
said setting and storing a desired location acquires a quick image using both the value of the encoder connected to the motor for adjusting the angle of the central axis of the camera with the ground, and the value of the encoder connected to the motor for adjusting the angle of the projection axis, formed when the central axis of the camera is projected onto the ground, with the reference axis.

10. The method according to claim 6, wherein said determining a width and a length of a defective region further comprises determining whether a target abnormal region to be determined to be a defect is included in the first image, clicking a mouse depending on a width and a length of the abnormal region, measuring the length and width of the abnormal region, and determining that the abnormal region is a defect when the measured length and width are greater than predetermined sizes.

11. The method according to claim 10, further comprising, after the primary defect measurement step:
returning the robot device to a stored origin in compliance with an origin return command;
setting and storing a desired location while a movement track of the robot device is being stored during movement of the robot device, and moving the robot device to a set location in compliance with a set location movement command; and
continuously storing a track of an inclination angle of the central axis of the camera, required for image acquisition, with the ground, a track of a rotation angle of the projection axis, formed when the central axis is projected onto the ground, with the reference axis, a track of a rotation angle of the focus control motor of the camera, and a track of a rotation angle of the zoom control motor of the camera while acquiring continuous images through the camera, and, if an image to be reviewed is set, storing an inclination angle of the central axis of the camera with the ground, a rotation angle of the projection axis, formed when the central axis is projected onto the ground, with the reference axis, and a rotation angle of the zoom control motor of the camera, at a time at which the set image was acquired, and thereafter adjusting a location and status of the camera using the stored values in compliance with a set image acquisition command, thus acquiring the set image.

12. The method according to claim 11, wherein:
said returning the robot device to a stored origin includes storing values of an encoder connected to wheels at a time of setting the origin and moving to the origin using the stored encoder values;
said controlling a posture of the camera includes using both a value of an encoder connected to a motor for adjusting an angle of the central axis of the camera with the ground and a value of an encoder connected to a motor for adjusting an angle of the projection axis, formed when the central axis is projected onto the ground, with the reference axis,
said acquiring a first image acquires the image by controlling the camera using a value of an encoder connected to the focus control motor of the camera and a value of an encoder connected to the zoom control motor of the camera, and
said setting and storing a desired location acquires a quick image using both the value of the encoder connected to the motor for adjusting the angle of the central axis of the camera with the ground, and the value of the encoder connected to the motor for adjusting the angle of the projection axis, formed when the central axis of the camera is projected onto the ground, with the reference axis.
